(19) United States
(12) Patent Application Publication
(10) Pub. No.: US 2013/0233392 A1
(43) Pub. Date: Sep. 12, 2013

(54) METHOD AND ARRANGEMENT FOR PROVIDING LNG FUEL FOR SHIPS

(71) Applicant: Harald Aarseth, Oslo (NO)

(72) Inventor: Harald Aarseth, Oslo (NO)

(73) Assignee: WARTSILA OIL & GAS SYSTEMS AS, Asker (NO)

(21) Appl. No.: 13/818,737

(22) PCT Filed: Aug. 25, 2011
(86) PCT No.: PCT/NO2011/000235

§ 371 Date: May 23, 2013

(30) Foreign Application Priority Data
Aug. 25, 2010 (NO) 20101189

(51) Int. Cl. F17C 9/02

(52) U.S. Cl. CPC F17C 9/02
USPC 137/1; 137/340

(57) ABSTRACT

An arrangement for providing liquefied natural gas (LNG) as fuel for propulsion of a ship (1, 6) having cargo tanks (2, 7) for liquefied gas comprises a source of LNG (3, 8) and at least one first heat exchanger (41) for vaporizing and/or heating the LNG directly or indirectly with a warmer medium (44). The warmer medium is boil-off gases from the cargo tanks (2, 7) being re-liquefied in the process.

The subject invention is related to transportation of liquefied gases at sea, and in particular for liquefied gases with a boiling temperature higher than minus 48° C.

Examples for such liquefied gases are propane, butanes, propylenes, vinyl chloride, butadiene, butylenes, ammonia, etc.

A common name for propane and butane is liquefied petroleum gases (LPG).

The invention might also to a certain extent be applied for gases with boiling temperatures as low as minus 105° C., and for liquefied gases as ethylene and ethane.

In the later years much attention has been drawn to the quality of bunker fuel for ships.

The common fuel for ocean-going ships has up to now been heavy fuel oil of different qualities.

However, due to environmental considerations, restrictions will be applied for use of such fuels in the future.

As alternative to heavy fuel oil, natural gas (mainly methane) is emerging, and has been applied for different types of ships.

Natural gas is a clean fuel, and with almost no emissions for nitrogen oxides and particles, and as well with about 25% less emissions of CO2 compared to oil.

An object of the subject invention is to make natural gas a especially useful and beneficial fuel for ships transporting liquefied gases with boiling temperatures higher than minus 48° C., and to a certain extent also for liquefied gases with boiling temperatures as low as minus 105° C.

The natural gas as fuel to ships are received in a liquid state (LNG=liquefied natural gas), and is stored in separate bunker tanks that might be of various configuration.

The storage temperature of the LNG is about minus 160° C.

However, prior to combustion at engine(s) in the engine room, the temperature of the natural gas has to be at about ambient temperature.

Accordingly, the LNG has to be vaporized and heated prior to use in engines.

Ships for transporting the liquefied gases as indicated above are normally provided with power-consuming devices for reliquefaction of vaporized gases (cargo).

Even the cargo tanks are insulated, some heat will leak into the cargo tanks, and some of the cargo will vaporize during voyage and in harbour.

In order to keep the gas pressure at permissible level in cargo tanks, the vapour has to be condensed in a reliquefaction plant, and returned to the cargo tanks in a liquid state.

The basic idea of the subject invention is to combine the energy demand for vaporization and/or heating of the LNG as fuel for propulsion of the ship, and the simultaneous energy released by condensation of the vaporized gases from the cargo tanks.

Preliminary calculations indicate an approximate balance between the energy demand for vaporization and/or heating of the necessary quantity of LNG for propulsion of the ship, and the simultaneously released energy at the re-liquefaction of the vaporized quantity of cargo.

The same heat exchanging principle is also normally applicable on ballasted voyages where the cargo tanks are almost empty for liquid contents, but still kept in a cold condition with a vapour atmosphere. The heat leakage from surroundings will tend to increase the cargo tank vapour pressure, but the heat exchanging with LNG will keep the pressure at low level, and which is beneficial for efficient loading of cargo in next harbour.

However, if any significant energy difference between vaporization and/or partial heating of LNG and re-liquefaction of cargo is calculated, the thickness of insulation for cargo tanks might be applied as a parameter for making better energy balance.

The vaporization and/or heating of LNG and the simultaneous condensation of liquefied cargo might be arranged in one or more heat exchangers, and in case the ship shall be arranged for transporting two or more different liquefied gas cargoes at a time, then the number of heat exchangers have to be provided accordingly for segregation of the cargoes.

Alternatively, the heat exchanging between LNG and vaporized cargo can take place in the vapour space of each cargo tank, and for example by letting the LNG be circulated in pipe coils, and the pipe coils can be provided with fins for improved performance.

An indirect heat transfer system might as well be applied, and whereby heat energy is transferred from the condensation of cargo to a circulating third medium (for example propane), and the energy is transferred from the third medium in a heat exchanger for vaporization and/or heating of the LNG.

The ship type for liquefied gas transportation with LNG fuelling will environmentally be very attractive with regard to emissions to air of harmful substances, and as well with regard to emission of greenhouse gases, and is expected to be in compliance with all future regulations and legislations for the said matters.

Moreover, the following significant cost savings are provided by the invention compared to a ship for transporting liquefied gases and applying fuel oils for propulsion:
Reduced number of refrigerating modules for re-liquefaction, and including associated pipe and electric cable systems, as the refrigerating modules now basically shall act as back-up only to the re-liquefaction by heat exchanging to the vaporization and/or heating of the LNG.
Reduced (or no) energy costs for running the re-liquefaction plant at loaded sea voyages.

Propulsion engines fuelled with LNG will normally be of the 2-stroke type or 4-stroke type.

The two types of gas engines have different supply systems for gas to the engines.

The 2-stroke gas engines are normally designed for receiving the gas fuel in a supercritical fluid state, and at a pressure in the range of about 200-300 bar for LNG as fuel, and at ambient temperature (20-40° C.).

One high-pressure pump will normally be installed on deck for supply of LNG in a super-critical state to the engine room, and with suction/supply to the pump from the LNG storage tank.

The temperature rise through the pump for LNG is estimated to be in the range of 15-20° C., and remaining temperature rise from about −140° C. to about ambient temperature shall according to subject invention be provided as much as practical via heat transfer from the re-liquefaction of cargo by heat exchangers on deck, and/or, by heat transfer in the vapour space of the cargo tanks.

The final heating until ambient temperature has to be provided by other heating source as steam, glycol/water-mixture, or similar.

The 4-stroke gas engines are normally designed for receiving the gas at a pressure in the range of about 3-6 bar, and at ambient temperature (20-40° C.).

For 4-stroke engines, the LNG will first be vaporized, and subsequently heated from the storage temperature of about −160° C. to about ambient temperature.

Also for 4-stroke engines, and according to the subject invention, the energy for vaporization of LNG and heating of gas shall as much as practical be provided via heat transfer from the re-liquefaction of cargo in heat exchangers on deck, and/or alternatively via heat transfer by devices in the vapour space of the cargo tanks.

Similar to the system for 2-stroke engines, the final heating until ambient temperature has to be provided separately by other heating source as steam, glycol/water mixture, or similar.

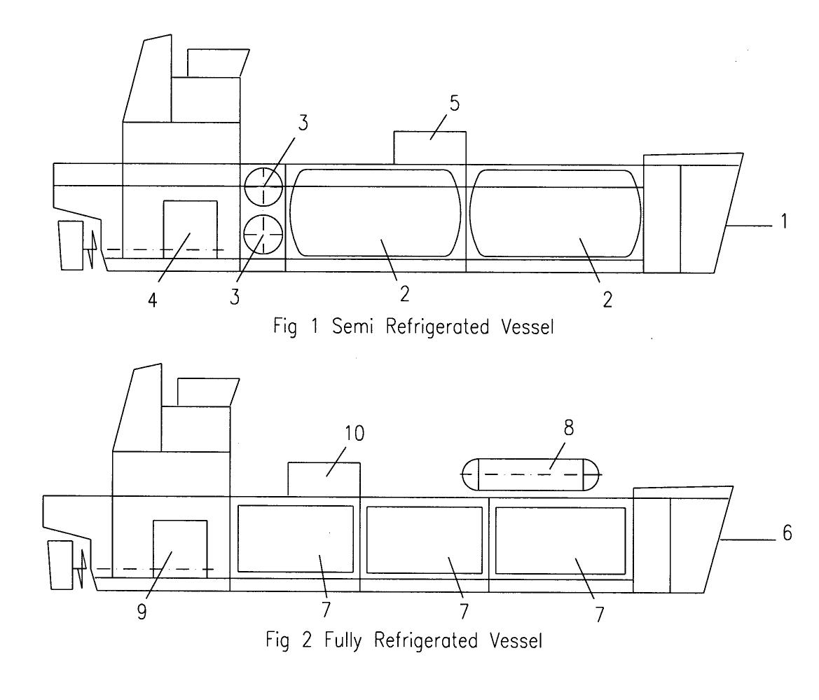

Types and locations of LNG storage tanks might be different from case to case, and typical locations are shown in attached FIG. 1 and FIG. 2.

In case all cargo tanks are provided with devices for heat exchanging in the vapour space, no additional installations are required for handling of the vaporized cargo when the ship is running on LNG.

In case heat exchanger(s) is installed outside the cargo tanks, it might additionally be necessary to install a, preferably variable, speed compressor with suction of vaporized gas from the cargo tanks.

The invention is defined the independent claims 1 and 9.

In order to visualize the subject invention, it will be described by reference to the non-limiting embodiments shown in the appended schematic figures, where:

FIG. 1 is a sectional view of a first ship suitable for use of the present invention;

FIG. 2 is a sectional view of a second ship suitable for use of the present invention;

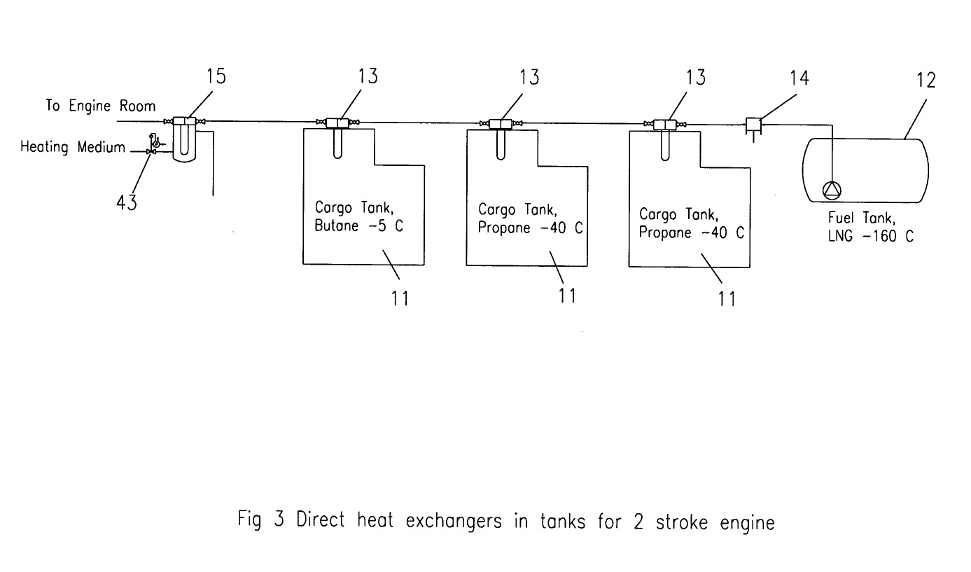

FIGS. 3 to 8 are flow plans illustrating different preferred embodiments of the present invention.

FIG. 1 shows a typical ship of semi-refrigerated type for transportation of liquefied gas.

Two cargo tanks of pressure vessel type (cylindrical) are typically shown, but number and type of pressure vessel tanks (spherical, bi-lobe, etc.), can be different for various ship projects of semi-refrigerated type.

1 is a typical ship of semi-refrigerated type.

2 are typical cargo tanks for LPG and other liquefied cargoes as specified above.

3 are storage tank(s) for LNG as fuel.

4 are main engine(s) using LNG as energy source.

5 is a deckhouse for accommodating the installations for re-liquefaction plant, and other cargo equipment.

FIG. 2 shows a typical ship of fully refrigerated type for transportation of liquefied gas.

Three prismatic cargo tanks are typically shown, but number of cargo tanks can be different for various ship projects of fully refrigerated type.

6 is a typical ship of fully refrigerated type.

7 is typical cargo tanks for LPG and other liquefied cargoes as specified above.

8 is storage tank(s) for LNG as fuel.

9 is main engine(s) using LNG as energy source.

10 is a deckhouse for accommodating the installations for re-liquefaction plant, and other cargo equipment.

FIG. 3 shows a typical flow scheme for a liquefied gas carrier of fully refrigerated type with main engine(s) of 2-stroke type, and with direct heat exchanging of liquefied cargo and fuel gas in the vapour space of cargo tanks.

11 is three cargo tanks of fully refrigerated type.

12 is storage tank for LNG as fuel, and with integral devices for supply of LNG (submerged pump as shown, or similar).

13 is heat exchangers in the vapour space of cargo tanks.

14 is high-pressure pump for LNG.

15 is heat exchanger for super-critical LNG, and for reaching ambient temperature with steam (or similar) as heating medium.

43 is a temperature control valve for the fuel to the engine.

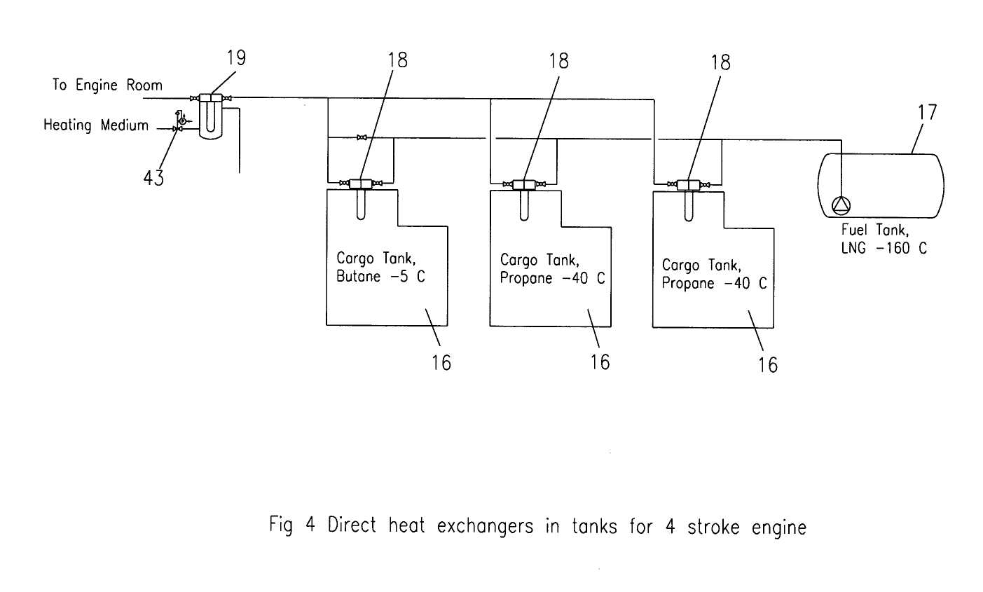

FIG. 4 shows a typical flow scheme for a liquefied gas carrier of fully refrigerated type, and with main engine(s) of 4-stroke type, and with direct heat exchanging of liquefied cargo and fuel gas in the vapour space of cargo tanks.

16 is three cargo tanks of fully refrigerated type.

17 is storage tank for LNG as fuel, and with integral devices for supply of LNG (submerged pump as shown, or similar).

18 is heat exchangers in the vapour space of cargo tanks.

19 is heat exchanger for vaporized LNG, and for reaching ambient temperature with steam (or similar) as heating medium.

43 is a temperature control valve for the fuel to the engine.

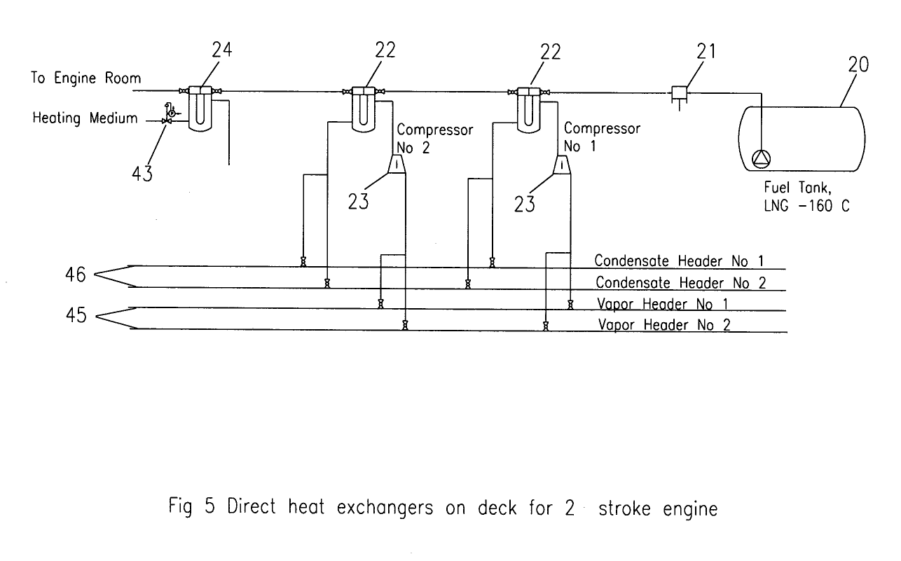

FIG. 5 shows a typical flow scheme for a liquefied gas carrier of fully refrigerated type, and with main engine(s) of 2-stroke type, and with heat exchanging between liquefied cargo and super-critical fuel gas in heat exchangers on deck.

20 is storage tank for LNG as fuel, and with integral devices for supply of LNG (submerged pump as shown, or similar).

21 is high-pressure pump for LNG.

22 is heat exchangers installed on deck, and two separate heat exchangers are shown indicating that two separate cargoes can be handled simultaneously.

23 is compressors for suction of vaporized cargo from cargo tanks, and with delivery through heat exchangers with sufficient pressure for condensate return to cargo tanks.

24 is heat exchanger for super-critical LNG, and for reaching ambient temperature with steam (or similar) as heating medium.

43 is a temperature control valve for the fuel to the engine.

45 is vapour headers with branches to the cargo tanks (not shown).

46 is condensate headers with branches to the cargo tanks (not shown).

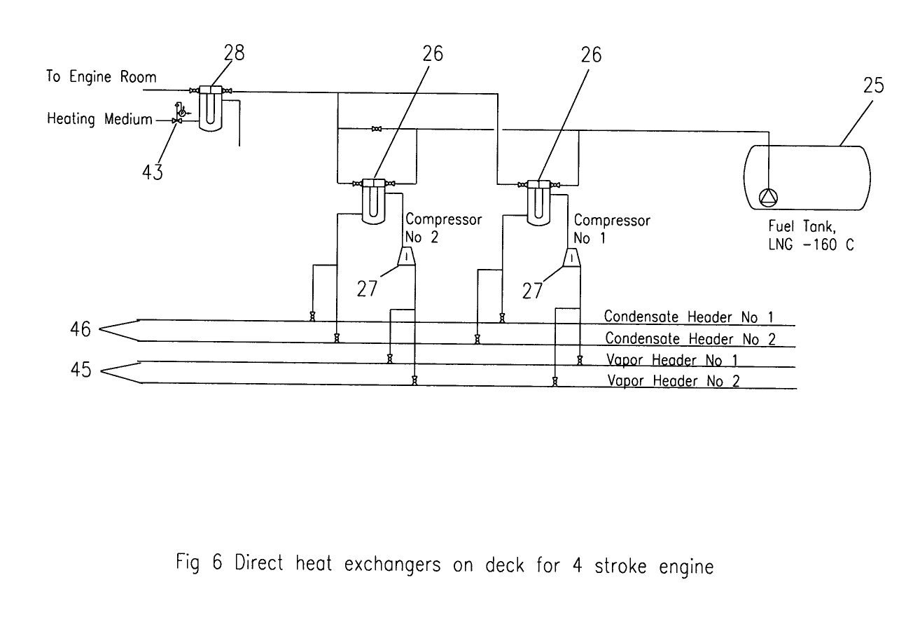

FIG. 6 shows a typical flow scheme for a liquefied gas carrier of either fully refrigerated, or semi-refrigerated type, and with main engine(s) of 4-stroke type, and with heat exchanging between liquefied cargo and LNG in heat exchangers on deck.

25 is storage tank for LNG as fuel, and with integral devices for supply of LNG (submerged pump as shown, or similar).

26 is heat exchangers installed on deck, and two separate heat exchangers are shown indicating that two separate cargoes can be handled simultaneously.

27 is compressors for suction of vaporized cargo from cargo tanks, and with delivery through heat exchangers with sufficient pressure for condensate return to cargo tanks.

28 is heat exchanger for vaporized LNG, and for reaching ambient temperature with steam (or similar) as heating medium.

43 is a temperature control valve for the fuel to the engine.

45 is vapour headers with branches to the cargo tanks (not shown).

46 is condensate headers with branches to the cargo tanks (not shown).

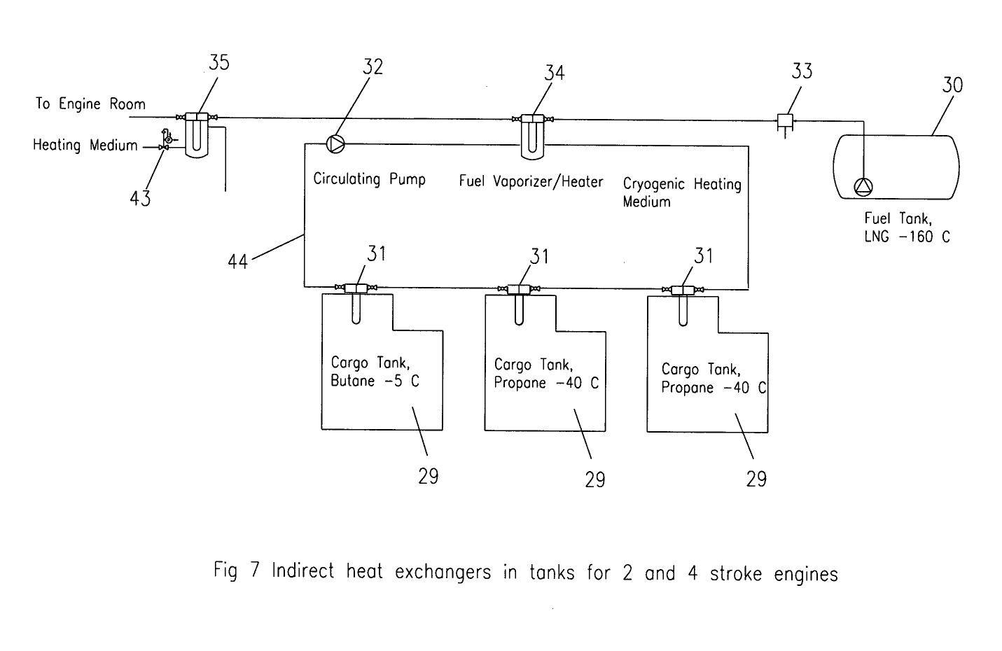

FIG. 7 shows a typical flow scheme for a liquefied gas carrier of fully refrigerated type, and with main engine(s) of either 2-stroke or 4-stroke type, and firstly with indirect heat exchanging in the vapour space of cargo tanks between vaporized cargo and a circulating cryogenic fluid, and secondly indirect heat exchanging between the circulating cryogenic fluid and LNG as fuel in another heat exchanger on deck.

29 is three cargo tanks of fully refrigerated type.

30 is storage tank for LNG as fuel, and with integral devices for supply of LNG (submerged pump as shown, or similar).

31 is heat exchangers in the vapour space of cargo tanks, and arranged for indirect heating to a circulating cryogenic fluid.

32 is a circulating pump for cryogenic fluid (propane, or similar) for indirect heat transfer.

33 is high-pressure pump for LNG (in case of 2-stroke main engine).

34 is heat exchanger on deck for heat exchanging between circulating cryogenic fluid and LNG as fuel.

35 is heat exchanger for super-critical LNG (2-stroke) or vaporized LNG (4-stroke), and for reaching ambient temperature with steam (or similar) as heating medium.

43 is a temperature control valve for the fuel gas to the engine.

44 is a closed loop for the cryogenic fluid.

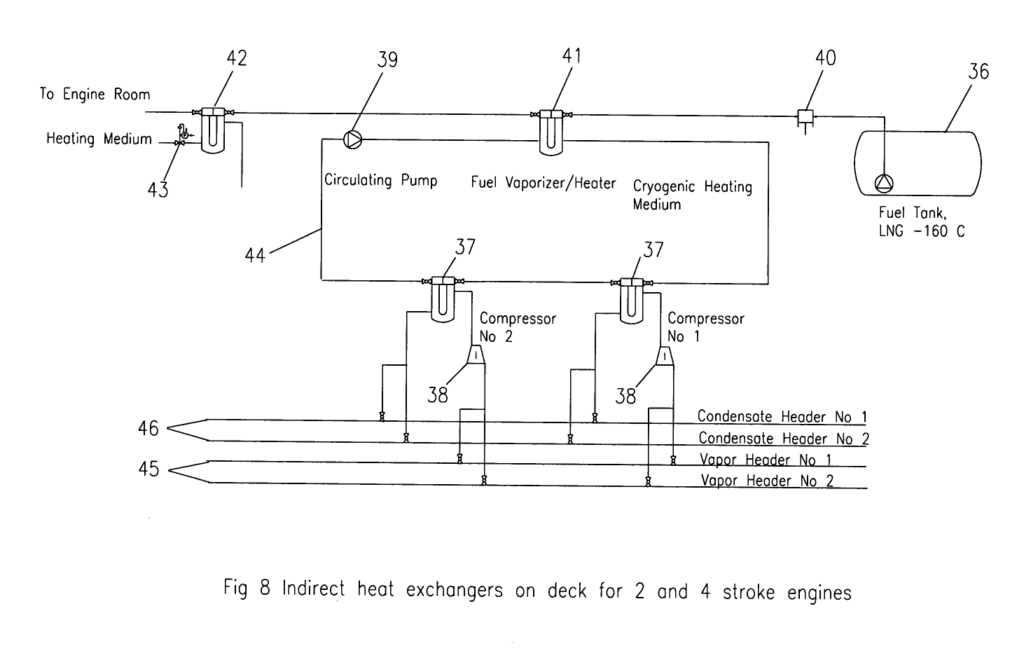

FIG. 8 shows a typical flow scheme for a liquefied gas carrier of either fully refrigerated, or semi-refrigerated type, and with main engine(s) of either 2-stroke or 4-stroke type, and firstly with indirect heat exchanging in heat exchangers on deck between vaporized cargo and a circulating cryogenic fluid, and secondly indirect heat exchanging between the circulating cryogenic fluid and LNG as fuel in another heat exchanger on deck.

36 is storage tank for LNG as fuel, and with integral devices for supply of LNG (submerged pump as shown, or similar).

37 is heat exchangers installed on deck, and two separate heat exchangers are shown indicating that two separate cargoes can be handled simultaneously.

38 is compressors for suction of vaporized cargo from cargo tanks, and with delivery through heat exchangers with sufficient pressure for condensate return to cargo tanks.

39 is a circulating pump for cryogenic fluid (propane, or similar) for indirect heat transfer.

40 is high-pressure pump for LNG (in case of 2-stroke main engine).

41 is heat exchanger on deck for heat exchanging between circulating cryogenic fluid and LNG as fuel.

42 is heat exchanger for vaporized LNG, and for reaching ambient temperature with steam (or similar) as heating medium.

43 is a temperature control valve for the fuel gas to the engine.

44 is a closed loop for the cryogenic fluid.

45 is vapour headers with branches to the cargo tanks (not shown).

46 is condensate headers with branches to the cargo tanks (not shown).

### PROCESS DESCRIPTION

In case of 2 stoke engine, and with reference to FIG. 3, the LNG fuel (12) is delivered to a high pressure booster pump (13) which are boosting the pressure over and above the critical pressure. At this pressure there is no vaporization of the liquid, and the LNG is successively heated by condensing cargo in the heat exchangers (13) installed in the vapour space of the tanks. Finally the LNG fuel is heated over and above the critical temperature in the supercritical heat exchanger (15), to the temperature required by the engine. This is regulated by a temperature control valve (43), which is regulating the heat supply to the heat exchanger.

Alternatively, and with reference to FIG. 5, the condensation of cargo may take place in heat exchangers on deck (22). The compressors (23) are drawing the cargo from the vapour header (45) and are returning it to the tanks through the condensate headers (46).

In case of a 4 stroke engine, and with reference to FIG. 4, the LNG fuel (17) is delivered without boosting in parallel to the heat exchangers (18) where the LNG is vaporizing at constant temperature. The fuel gas is further heated in an ordinary gas heater (19), to the temperature required by the engine. This is regulated by a temperature control valve (43), which is regulating the heat supply to the heat exchanger.

Alternatively, and with reference to FIG. 6, the condensation of cargo may take place in heat exchangers on deck (26). The compressors (27) are drawing the cargo from the vapour headers (45) and are returning it to the tanks through the condensate headers (46).

Alternatively for both cases and with reference to FIG. 7, the condensation of cargo takes place in the cargo tanks (37) and the heat is brought to a single vaporizer/fuel heater (34) on deck by a circulating cryogenic heating medium (44).

Alternatively for both cases, and with reference to FIG. 8, both condensation of cargo (37) and vaporization/heating of fuel (41) takes place in heat exchangers on deck. Similar to FIG. 6, the compressors (37) are drawing the cargo from the vapour headers (45) and are returning it to the tanks through the condensate headers (46).

1. A method for vaporizing and/or heating a first liquefied gas for use as fuel for a ship having a cargo tank containing a second liquefied gas, comprising:
taking the heat for vaporization and/or heating of a first liquefied gas from the contents of a cargo tank; and
obtaining the heat through heat exchange with and condensation of boil-off from the contents of the cargo tank, wherein the first liquefied gas has a lower boiling point than a second liquefied gas.

2. A method according to claim 1, wherein the first liquefied gas is LNG.

3. A method according to claim 1, wherein the second liquefied gas has a boiling point higher than −105° C.

4. A method according to claim 1, wherein the boiling point of the second liquefied gas is higher than −48° C.

5. A method according to claim 1, wherein the second liquefied gas is LPG.

6. A method according to claim 1, wherein obtaining the heat further comprises the heat exchange between LNG as fuel and cargo boil-off being made by heat exchanging in a vapour space in an upper part of the cargo tank.

7. A method according to claim 1, wherein obtaining the heat further comprises the heat exchange between LNG as fuel and cargo boil-off being made in separately installed heat exchangers.

8. A method according to claim 1, wherein obtaining the heat further comprises the heat exchange between LNG as fuel and cargo boil-off being made indirectly by a circulating cryogenic medium in a loop including a second heat exchanger between the cryogenic medium and the LNG to be heated.

9. An arrangement for providing liquefied natural gas (LNG) as fuel for propulsion of a ship comprising:
a cargo tank for liquefied gas having a higher temperature than LNG, a source of LNG, and a first heat exchanger for vaporizing and/or heating the LNG with heat being taken from the contents of the cargo tank, and
heat transfer means for providing the first heat exchanger with heat from boil-off gases from the cargo tank.

10. The arrangement according to claim 9, comprising back-up module(s) only for re-liquefaction of cargo boil-off not condensed by vaporization of LNG.

11. The arrangement according to claim 9, wherein the first heat exchanger is located in a vapour at an upper part of the cargo tank.

12. The arrangement according to claim 9, wherein the first heat exchanger is a separately installed heat exchanger.

13. The arrangement according to claim 9, comprising a loop circulating cryogenic medium for indirect heat exchange between LNG as fuel and cargo boil-off, and a second heat exchanger in the loop exchanging heat between the cryogenic medium and the LNG to be heated.

14. The arrangement according to claim 9, wherein a compressor is provided for delivery of cargo boil-off to the first heat exchanger.

15. The arrangement according to claim 14, wherein the compressor is also used in a back-up system for re-liquefaction of cargo boil-off.

16. The arrangement according to claim 9, further comprising a 2-stroke gas engine to receive the LNG.

17. The arrangement according to claim 9, further comprising a 4-stroke gas engine to receive the LNG.

18. The arrangement according to claim 13, further comprising a 2-stroke gas engine to receive the LNG.

19. The arrangement according to claim 13, further comprising a 4-stroke gas engine to receive the LNG.

20. The arrangement according to claim 9, further comprising a third heat exchanger outside the cargo tank.
